(19) United States
(12) Patent Application Publication
(10) Pub. No.: US 2009/0080434 A1
(43) Pub. Date: Mar. 26, 2009

(54) IMA automatic cell scrambling detection

(75) Inventor: Sasha Rantsevitch, Dunrobin (CA)

Correspondence Address: GALASSO & ASSOCIATES, LP, P.O. BOX 26503, AUSTIN, TX, 78755-0503, US

(73) Assignee: ALCATEL-LUCENT

(21) Appl. No.: 11/886,978

(22) Filed: Sep. 21, 2007

(51) Int. Cl. H04L 12/28

(52) U.S. Cl. 370/395.5

(57) ABSTRACT

IMA Automatic Cell Scrambling Detection is a method for automatic IMA cell scrambling detection and configuration. The preferred embodiment of the invention utilizes a method whereby upon detection of a LIF condition on an IMA link, the edge services extender card periodically toggles the configuration of ATM cell payload scrambling from enabled to disabled until IMA framing is detected.

### CROSS REFERENCE TO RELATED APPLICATIONS

This United States Non-Provisional Patent Application does not claim priority to any United States Provisional Patent Application or any foreign patent application.

### FIELD OF THE DISCLOSURE

The disclosures made herein relate generally to the routing switch platform industry. The invention discussed herein is in the general classification of automatic inverse multiplexing over asynchronous transfer mode scrambling detection for use with routing switch platforms and other devices.

### BACKGROUND

The Alcatel-Lucent 7670 routing switch platform (RSP) is a highly scalable and configurable switching and routing platform designed to provide carriers with the utmost flexibility to increase revenue-generating opportunities. Optimized for the next generation multiservice Internet Protocol (IP) network, the Alcatel-Lucent 7670 RSP delivers new voice over IP (VoIP), IP, virtual private network (VPN) and multimedia services as well as existing data services and service level agreements.

By integrating both IP/multiprotocol label switching (MPLS) and asynchronous transfer mode (ATM) control planes on a scalable, high availability architecture that can scale without service disruption, Alcatel-Lucent has leveraged a pedigree in building in-service scalable data networking platforms to deliver a reliable, carrier class product. These unique attributes enable a more simplified and efficient network architecture, resulting in significant operational and capital savings for network operators.

This multiservice IP platform delivers multiple Layer 3 and Layer 2 services reliably and concurrently. Any service can be provided, using IP, MPLS, ATM, time division multiplexing (TDM), frame relay, Gigabit Ethernet (GigE), 10/100 Ethernet, and packet over synchronous optical network (SONET) (POS). By allowing service providers to harmoniously mix new and traditional services on their existing infrastructure, they can protect established, high revenue services and role out new services quickly—throughout the entire serving area.

By focusing on the delivery of new and reliable IP and Ethernet services and existing services independent of the underlying network technologies, the Alcatel-Lucent multiservice IP platform provides carriers the bridge to enable a staged migration to converged networks today. In addition, the industry-leading Alcatel-Lucent 5620 management portfolio provides carriers with innovative tools to manage sensitive, real-time voice and data traffic including end-to-end service interworking and migration across multiple technologies.

Unfortunately, mismatching cell scrambling at Alcatel-Lucent's 7670 RSP ESC (Edge Services Extender Card) and node-B has been a problem during testing of the 7670 RSP IMA interoperability with Nokia and Ericsson Node-Bs. IMA stands for Inverse Multiplexing over ATM and is a specification that provides a way to combine an ATM cell stream over two or more circuits, thus allowing an organization to lease just the bandwidth it needs.

The mismatching cell scrambling manifests itself as a LIF (Loss of IMA Frame) condition at the Alcatel-Lucent 7670 RSP ESC. The LIF condition is caused by the behavior outlined in conjunction with the detailed description of FIG. 1. Essentially, the ATM transmitter and the ATM receiver must be configured to either scramble/descramble or to not scramble/descramble. If the ATM transmitter and ATM receiver configurations are mismatched, then the ATM cell payload will be corrupted after either the receiver applies the descrambling algorithm for a non-scrambled payload; or the receiver does not apply the descrambling algorithm for a scrambled payload.

Unfortunately, Ericsson and Nokia support (or recommend the operator to select) different cell scrambling methods. Ericsson has it enabled, and Nokia has it disabled. Therefore, depending on whether the far end Node-B system is a Nokia or Ericsson system, cell scrambling on the IMA connection has to be set to disabled or enabled, respectively. It is not possible to determine from the cells received at the Alcatel-Lucent 7670 RSP ESC whether the Node-B has used cell scrambling or not. It also is not possible to detect whether the Node-B at the far end is Ericsson, Nokia, or another vendor's Node-B.

The best existing solution to this problem is to manually verify whether cell scrambling is enabled on the Node-B system that is transmitting IMA cells to the Alcatel-Lucent 7670 RSP or other similar device. This can be done at a network or element management system that manages the Node-B system. However, this takes time and that management system might not be available to the operator that is configuring the 7670 RSP ESC or other similar card. Furthermore, cell scrambling can be assigned at the IMA channel, IMA group or card level, which can be very time consuming to check and configure as necessary, especially if done at the IMA channel level.

Hence, there is a need in the art for a convenient to install, reliable, inexpensive and automatic method for ascertaining whether cell scrambling is enabled on the Node-B system that is transmitting IMA cells to a routing switch platform such as the Alcatel-Lucent 7670 RSP or other similar device.

### SUMMARY OF THE DISCLOSURE

IMA Automatic Cell Scrambling Detection is a method for automatic IMA cell scrambling detection and configuration.

The preferred embodiment of the invention utilizes a method whereby upon detection of a LIF condition on an IMA link, the Alcatel-Lucent 7670 RSP ESC card or other similar card periodically toggles the configuration of ATM cell payload scrambling from enabled to disabled until IMA framing is detected.

The principal object of this invention is to provide a method for automatic IMA cell scrambling detection and configuration.

Another object of this invention is to provide a method for automatic IMA cell scrambling detection and configuration that is relatively inexpensive to install and maintain.

Another object of this invention is to provide a reliable method for automatic IMA cell scrambling detection and configuration.

Yet another object of this invention is to provide a method for automatic IMA cell scrambling and detection that is not time consuming to implement.

### BRIEF DESCRIPTION OF THE DRAWINGS

FIG. 1 depicts an IMA group with a properly configured ATM receiver and ATM transmitter.

### DETAILED DESCRIPTION OF THE DRAWINGS

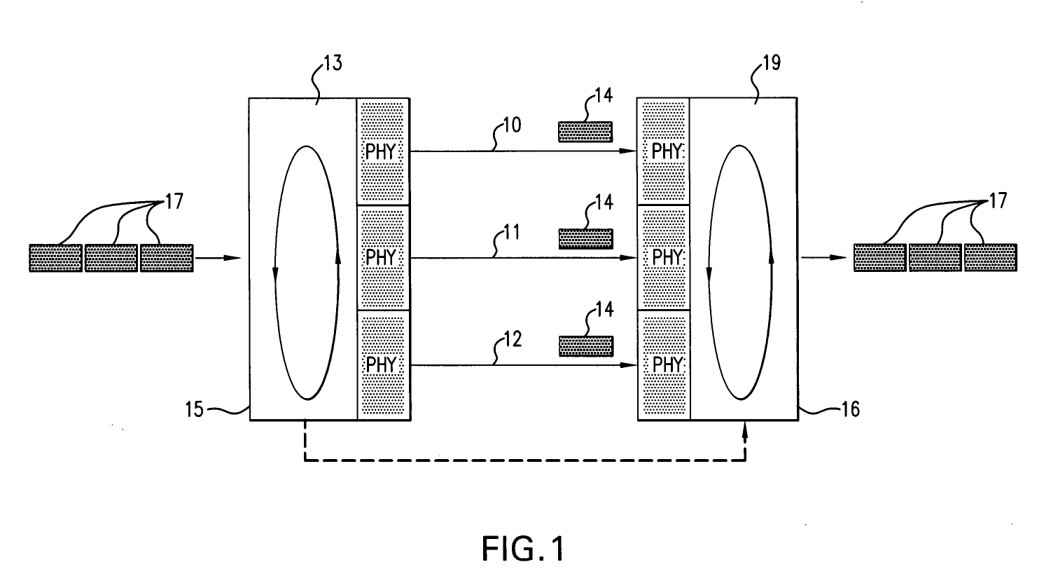

FIG. 1 depicts an IMA group with a properly configured ATM eceiver and ATM transmitter. The ATM transmitter 15 applies ATM cell payload scrambling as per ITU-T 1.432 to an incoming ATM payload 17. ATM cells 14 are distributed on a first physical link 10, a second physical link 11 and a third physical link 12 in the IMA group 13. The first physical link 10, the second physical link 11 and the third physical link 12 in the IMA group 13 can be DS1 or E1 interfaces, or they can be DS1 or El channels in a SONET/SDH interface. The ATM cells 14 could flow on each link in both directions.

The ATM receiver 16 applies ATM cell payload descrambling as per ITU-T 1.432 to the incoming ATM cells. The ATM payload 17 is then recombined and transmitted by the ATM receiver 16. Alternatively, the ATM transmitter could be set to not apply ATM cell payload scrambling and the ATM receiver can be set to not apply ATM cell payload descrambling. In either case, both the ATM transmitter and the ATM receiver must be configured to either scramble/descramble or to not scramble/descramble for the system to work properly.

If the ATM transmitter and the ATM receiver configurations are mismatched, then the ATM cell payload will be corrupted after either the receiver applies the descrambling algorithm for a non-scrambled payload; or the receiver does not apply the descrambling algorithm for a scrambled payload.

When the ATM transmitter and the ATM receiver are configured properly as in FIG. 1, the received ATM cells with the correct payload are passed onto the IMA layer 19 in the ATM receiver 16. The IMA layer 19 detects IMA control protocol (ICP) cells based on a particular pattern in the payload. ICP cells are a feature in the IMA. A receiving interface uses ICP cells to determine the differential delay between the links in the IMA group. ICP cells are sent on each link once per IMA frame. By default, each frame consists of 128 cells. The ICP cell can be located anywhere inside the frame (cell 0-cell 127). After detecting a number of ICP cells in the ATM cell flow following each other in a certain order, the IMA layer detects IMA framing, and the LIF condition clears.

However, when the payload is corrupted, the ICP cells cannot be detected, and the IMA link remains in LIF. Both the ATM transmitter and the ATM receiver must be configured to either scramble or not scramble in order for the system to function properly.

As previously discussed, Ericsson and Nokia support (or recommend the operator to select) different cell scrambling methods. Ericsson has it enabled, and Nokia has it disabled. Therefore, depending on whether the far end Node-B system is a Nokia or Ericsson system, cell scrambling on the IMA connection has to be set to disabled or enabled, respectively. It is not possible to determine from the cells received at the Alcatel-Lucent 7670 RSP ESC whether the Node-B has used cell scrambling or not or whether the Node-B at the far end is Ericsson, Nokia, or another vendor's Node-B.

To solve this problem an automatic IMA cell scrambling detection and configuration needs to be provided. In the present invention, upon detection of a LIF condition on an IMA link, the 7670 RSP ESC card located in the ATM receiver periodically toggles the configuration of ATM cell payload scrambling from enabled to disabled until IMA framing is detected. In the preferred embodiment, the period of the toggling can be constant, e.g. every 5 seconds. However, the period of toggling can also be gradually increased, e.g. every 5-10-30 seconds. There may be a small delay of one or two toggling cycle periods before IMA cell scrambling is automatically detected and configured.

In other embodiments, this procedure may be enabled at the IMA group or at the IMA link level until LIF conditions on all IMA links have been cleared.

This method will save operator time and reduce possible downtime during IMA link configuration. This method will be more useful as the Alcatel-Lucent 7670 RSP ESC extends its support to higher bandwidth links that support more IMA channels and therefore take more work and time to resolve IMA cell scrambling misconfiguration problems. Also, the solution may be extended to other Alcatel products supporting IMA, e.g. 7670 ESE and 7750 SR.

The materials utilized in the devices implementing the method described herein may vary widely but could include metal, plastic and electrical components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It should be obvious that routing switch platforms besides the Alcatel-Lucent 7670 could also benefit from the implementation of the method described herein. The use of the Alcatel-Lucent 7670 in this specification is merely by way of example and not limitation as to the methodology described herein. Routing switch platforms from other venders as well as other devices may implement the method described herein.

It is contemplated that the method described herein can be implemented as software, including a computer-readable medium having program instructions executing on a computer, hardware, firmware, or a combination thereof. The method described herein also may be implemented in various combinations on hardware and/or software.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A method for automatic IMA cell scrambling detection and configuration comprising the steps of:
(a) receiving an ATM cell payload;
(b) detecting a LIF condition on an IMA link associated with the ATM cell payload;
(c) toggling the configuration of ATM cell payload scrambling from enabled to disabled until IMA framing is detected;
(d) clearing the LIF condition when IMA framing is detected.

2. The method of claim 1 wherein the toggling the configuration of ATM payload scrambling from enabled to disabled until IMA framing is detected occurs on a constant time basis.

3. The method of claim 1 wherein the toggling the configuration of ATM payload scrambling from enabled to disabled until IMA framing is detected occurs in gradually increasing increments of time.

4. The method of claim 1 further comprising the step of:
combining the ATM cell payload into an ATM payload

5. The method of claim 4 further comprising the step of:
transmitting the ATM payload.
